(19) United States
(12) Patent Application Publication
(10) Pub. No.: US 2006/0250707 A1
(43) Pub. Date: Nov. 9, 2006

(54) Optical film having a surface with rounded pyramidal structures

(75) Inventors: Leland R. Whitney, St. Paul, MN (US); Byungsoo Ko, Seoul (KR); Mark E. Gardiner, Santa Rosa, CA (US); Dongwon Chae, Suwon City (KR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/122,864

(22) Filed: May 5, 2005

(51) Int. Cl. G02F 1/1335

(52) U.S. Cl. 359/831; 359/599

(57) ABSTRACT

Optical films are disclosed that include a body having a first surface, an axis and a structured surface including a plurality of pyramidal structures. Each pyramidal structure has a rounded tip and a base including at least two first sides disposed opposite to each other and at least two second sides disposed opposite to each other. Also disclosed are optical devices including such optical films.

### FIELD OF THE INVENTION

The present disclosure is directed to structured optical films and, more specifically, to optical films that include rounded pyramidal structures and optical devices incorporating such optical films.

### BACKGROUND

Display devices, such as liquid crystal display (“LCD”) devices, are used in a variety of applications including, for example, televisions, hand-held devices, digital still cameras, video cameras, and computer monitors. An LCD offers several advantages over a traditional cathode ray tube (“CRT”) display such as decreased weight, unit size and power consumption. However, an LCD panel is not self-illuminating and, therefore, sometimes requires a backlighting assembly or a “backlight.” A backlight typically couples light from one or more sources (e.g., a cold cathode fluorescent tube (“CCFT”) or light emitting diode (“LED”)) to a substantially planar output. The substantially planar output is then coupled to the LCD panel.

The performance of an LCD is often judged by its brightness. Brightness of an LCD may be enhanced by using a larger number of light sources or brighter light sources. In large area displays it is often necessary to use a direct-lit type LCD backlight to maintain brightness, because the space available for light sources grows linearly with the perimeter while the illuminated area grows as the square of the perimeter. Therefore, larger LCD televisions typically use a direct-lit backlight instead of a light-guide edge-lit type LCD backlight. Additional light sources and/or a brighter light source may consume more energy, which is counter to the ability to decrease the power allocation to the display device. For portable devices this may correlate to decreased battery life. Also, adding a light source to the display device may increase the product cost and weight and sometimes can lead to reduced reliability of the display device.

Brightness of an LCD device may also be enhanced by more efficiently utilizing the light that is available within the LCD device (e.g., to direct more of the available light within the display device along a preferred viewing axis). For example, Vikuiti™ Brightness Enhancement Film (“BEF”), available from 3M Company, has prismatic surface structures, which redirect some of the light exiting the backlight outside the viewing range to be substantially along the viewing axis. At least some of the remaining light is recycled via multiple reflections of some of the light between BEF and reflective components of the backlight, such as its back reflector. This results in optical gain substantially along the viewing axis and also results in improved spatial uniformity of the illumination of the LCD. Thus, BEF is advantageous, for example, because it enhances brightness and improves spatial uniformity. For a battery powered portable device, this may translate to longer running times or smaller battery size, and a display that provides a better viewing experience.

### SUMMARY

In one aspect, the present disclosure is directed to optical films including a body having a first surface, an axis and a structured surface including a plurality of pyramidal structures. Each pyramidal structure has a rounded tip and a base including at least two first sides disposed opposite to each other and at least two second sides disposed opposite to each other. The optical films may further include a substrate portion having an additional optical characteristic different from an optical characteristic of the structured surface. In some exemplary embodiments, the substrate portion comprises at least one of: a polarizer, a diffuser, a brightness enhancing film, and a turning film. The present disclosure is also directed to optical devices including such optical films.

In another aspect, the present disclosure is directed to optical films including a body having a first surface, an axis and a structured surface including a plurality of pyramidal structures. Each pyramidal structure has a rounded tip and a base including at least two longer sides disposed opposite to each and at least two shorter sides disposed opposite to each other. In some exemplary embodiments, such optical films include a substrate portion that comprises at least one of: a polarizer, a diffuser, a brightness enhancing film, and a turning film. The present disclosure is also directed to optical devices including such optical films.

These and other aspects of the optical films and optical devices of the subject invention will become more readily apparent to those having ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1A shows schematically a planar lightguide edge-lit backlight;

FIG. 1B shows schematically a wedge lightguide edge-lit backlight;

FIG. 1C shows schematically a backlight utilizing an extended light source;

FIG. 1D shows schematically a direct-lit backlight;

FIG. 2 shows schematically an exemplary embodiment of an optical film according to the present disclosure disposed over a backlight;

FIG. 3A is a schematic partial perspective view of an exemplary optical film constructed according to the present disclosure;

FIG. 3B is a partial cross-sectional view of the exemplary optical film shown in FIG. 3A;

FIG. 3C is another partial cross-sectional view of the exemplary optical film shown in FIG. 3A;

FIG. 4A shows schematically a top view of an individual pyramidal structure of an exemplary optical film according to the present disclosure;

FIG. 4B shows schematically a cross-sectional view of the pyramidal structure illustrated in FIG. 4A;

FIG. 4C shows schematically another cross-sectional view of the pyramidal structure illustrated in FIG. 4A;

FIG. 5A shows schematically a cross-sectional view of a pyramidal structure of an exemplary optical film according to the present disclosure, positioned over a backlight;

FIG. 5B shows schematically another cross-sectional view of the pyramidal structure illustrated in FIG. 5A;

FIG. 6A is a schematic partial perspective view of an exemplary optical film constructed according to the present disclosure;

FIG. 6B is an iso-candela polar plot for the exemplary optical film shown in FIG. 6A;

FIG. 6C contains rectangular distribution plots, representing cross-sections of the data shown in FIG. 6B taken at 0, 45, 90 and 135 degree angles;

FIG. 7A is a schematic partial perspective view of another exemplary optical film constructed according to the present disclosure;

FIG. 7B is an iso-candela polar plot for the exemplary optical film shown in FIG. 7A;

FIG. 7C contains rectangular distribution plots, representing cross-sections of the data shown in FIG. 7B taken at 0, 45, 90 and 135 degree angles;

FIG. 8A is a schematic partial perspective view of yet another exemplary optical film constructed according to the present disclosure;

FIG. 8B is an iso-candela polar plot for the exemplary optical film shown in FIG. 8A; and

FIG. 8C contains rectangular distribution plots, representing cross-sections of the data shown in FIG. 8B taken at 0, 45, 90 and 135 degree angles.

### DETAILED DESCRIPTION

The present disclosure is directed to optical films capable of controlling angular distribution of light and optical devices incorporating such optical films. In particular, the optical films according to the present disclosure may be capable of controlling angular output distribution of light from a backlight, such as an LCD backlight.

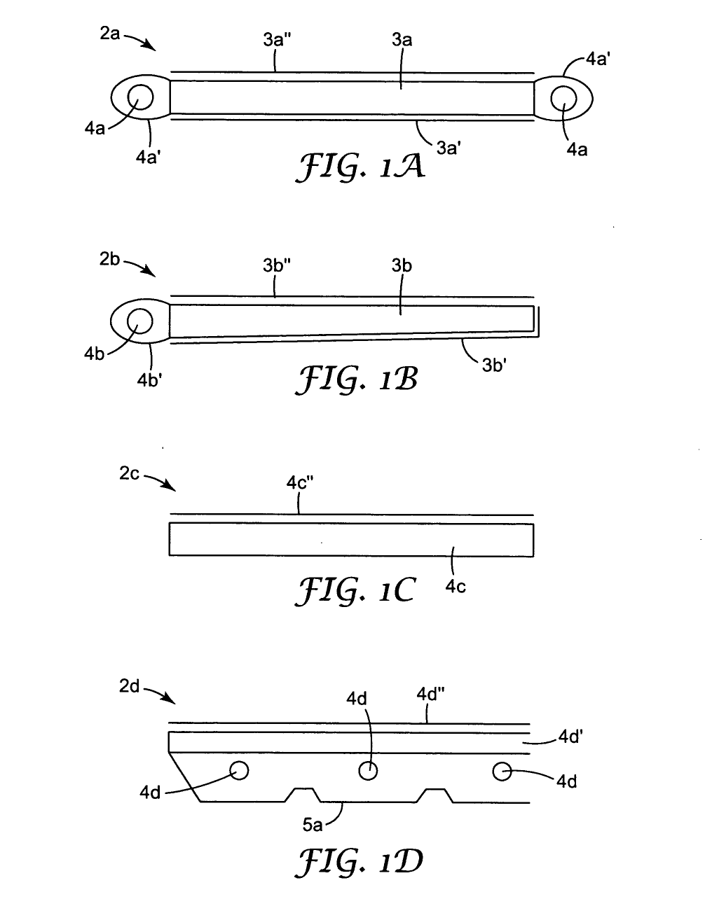

FIGS. 1A-1D show several examples of optical devices, such as backlights, that may be used with LCD panels. FIG. 1A shows a backlight 2a. The backlight 2a includes a lightguide 3a, which is illustrated as a substantially planar lightguide, light sources 4a disposed on one, two or more sides of the lightguide 3a, such as CCFTs or arrays of LEDs, lamp reflectors 4a′ disposed about the light sources 4a, a back reflector 3a′ and one or more optical films 3a′, which may be any suitable optical films. FIG. 1B shows a backlight 2b including a lightguide 3b, which is illustrated as a wedge-shaped lightguide, a light source 4b disposed on one side of the lightguide 3b, such as one or more CCFTs or an array of LEDs, a lamp reflector 4b′ disposed about the light source 4b, a back reflector 3b′ and one or more optical films 3b′, which may be any suitable optical films. FIG. 1C shows a backlight 2c, which includes an extended light source 4c, which may be a surface emission-type light source, and one or more optical films 4c′ disposed over the extended light source 4c. FIG. 1D shows schematically a partial view of a direct-lit backlight 2d, which includes three or more light sources 4d, such as CCFTs or arrays of LEDs, a back reflector 5a, a diffuser plate 4d′ and one or more optical films 4d″, which may be any suitable optical films.

Such backlights may be used in various other optical devices, such as display devices using LCDs (e.g., televisions, monitors, etc). As one of ordinary skill in the art will understand, a display device may include a case having a window, a backlight, which may include at least one light source, a light-distributing element such as a lightguide, an optical film according to the present disclosure, other suitable optical films, and a light-gating device, such as an LCD panel, situated between the optical film and the optical window and disposed to receive light transmitted through the optical film. The optical film according to the present disclosure may be used in conjunction with any suitable light source known to those of ordinary skill in the art and the display device may include any other suitable elements.

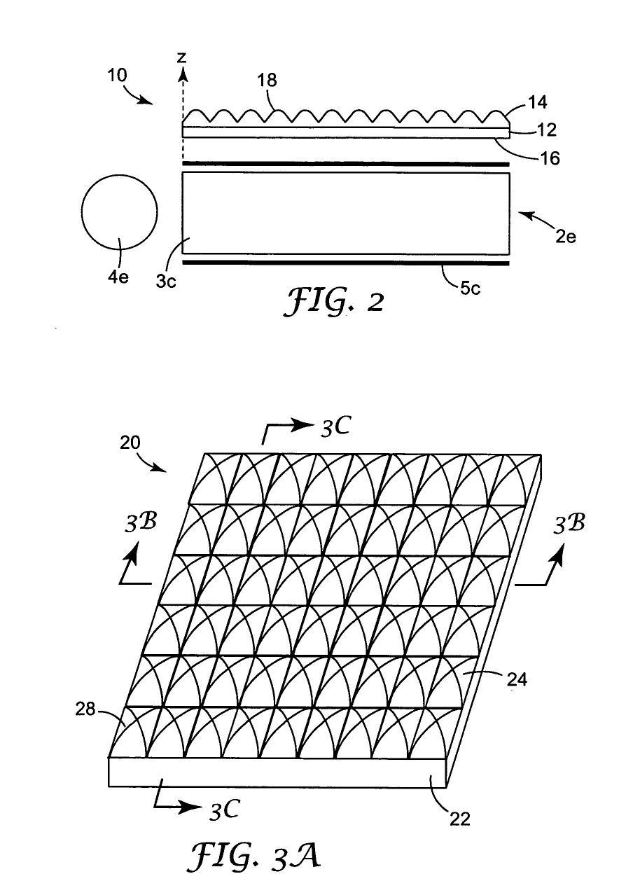

FIG. 2 shows a cross-sectional view of a backlight 2e and an optical film 10 according to the present disclosure disposed over the backlight 2e so that a surface 16 (e.g., a first surface) of the optical film 10 receives light from the backlight. The backlight 2e may include a light source 4e, a light distributing element 3c, such as a lightguide, and a back reflector 5c. The optical film 10 according to the present disclosure has a structured surface 14 (e.g., a second surface) carrying closely packed rounded pyramidal structures 18. In typical embodiments of the present disclosure, the structured surface 14 faces away from the backlight 2e. The optical film 10 may further include a substrate portion 12. The optical film 10 may be characterized by an axis z, which in some exemplary embodiments is substantially perpendicular to the substrate portion 12 and/or the surface 16. In other exemplary embodiments, the axis z makes a different angle with respect to the substrate portion 12 and/or the surface 16. In typical embodiments of the present disclosure, the axis z is substantially collinear with a viewing direction of a display device in which the optical films of the present disclosure can be used.

As one of ordinary skill in the art would understand, the closely packed rounded pyramidal structures 18 and the substrate portion 12 may be formed as a single part, and in some cases from the same material, to produce the optical film 10, or they may be formed separately and then joined together to produce a single part, for example, using a suitable adhesive. In some exemplary embodiments, the array of closely packed rounded pyramidal structures 18 may be formed on the substrate portion 12.

The closely packed rounded pyramidal structures 18 of the optical film 10 may be used to control the direction of light transmitted through the optical film 10, and, particularly, the angular spread of output light. The closely packed rounded pyramidal structures 18 can be arranged on the surface 14 side-by-side and in close proximity to one another, and, in some exemplary embodiments, in substantial contact or immediately adjacent to one another. In other exemplary embodiments, the rounded pyramidal structures 18 may be spaced from each other provided that the gain of the optical film 10 is at least about 1.1. For example, the rounded pyramidal structures 18 may be spaced apart to the extent that the structures occupy at least about 50% of a given useful area of the structured surface 14, or, in other exemplary embodiments, the rounded pyramidal structures 18 may be spaced further apart to the extent that the structures occupy no less than about 20% a given useful area of the structured surface 14. The pyramidal structures 18 may be two-dimensionally aligned with each other, offset with respect to one another (angularly, transversely or both) or arranged in a random distribution. Suitable offset arrangements of the pyramidal structures 18 are described in the commonly owned U.S. application Ser. No. U.S. application Ser. No. 11/026,938, by Ko et al., filed on Dec. 30, 2004, the disclosure of which is hereby incorporated by reference herein to the extent it is not inconsistent with the present disclosure.

Typical exemplary optical films constructed according to the present disclosure usually are capable of providing optical gain of at least about 1.1 to at least about 1.56. For the purposes of the present disclosure, “gain” is defined as the ratio of the axial output luminance of an optical system with an optical film constructed according to the present disclosure to the axial output luminance of the same optical system without such optical film. In typical embodiments of the present disclosure, the size, shape and spacing of (or a given useful area covered by) the rounded pyramidal structures 18 are selected to provide an optical gain of at least about 1.1. Generally, the rounded pyramidal structures 18 should not be so small as to cause diffraction effects and not so large as to be readily apparent to a viewer of a display device containing the optical film. In some exemplary embodiments that are particularly suitable for use in direct-lit backlights, the spacing, size, and shape of the rounded pyramidal structures 18 can be chosen so that the optical films of the present disclosure aid in hiding from the viewer light sources used in the backlight.

The rounded pyramidal structures 18, and, in some embodiments, at least an adjacent part of the substrate portion 12 including the surface 14, can be made from transparent curable materials, such as low refractive index or high refractive index polymeric materials. With high refractive index materials, higher optical gain may be achieved at the expense of a narrower viewing angle, while with lower refractive index materials, wider viewing angles may be achieved at the expense of lower optical gain. Exemplary suitable high refractive index resins include ionizing radiation curable resins, such as those disclosed in U.S. Pat. Nos. 5,254,390 and 4,576,850, the disclosures of which are incorporated herein by reference to the extent they are consistent with the present disclosure.

In some exemplary embodiments, refractive index of the rounded pyramidal structures 18 is higher than that of at least a layer of the substrate portion. Some known materials suitable for forming the rounded pyramidal structures 18 have refractive indices of about 1.6, 1.65, 1.7 or higher. In other exemplary embodiments, the rounded pyramidal structures 18 may be formed from materials having lower refractive indices, such as acrylic with the refractive index of 1.58 or poly methyl methacrylate (PMMA) with a refractive index of 1.49. In some such exemplary embodiments, for a polyethylene terephthalate substrate having a refractive index of about 1.66, a preferred range of refractive indices of the structures 18 (and, perhaps, an adjacent portion of the film) is from about 1.55 to about 1.65. In yet other exemplary embodiments, the rounded pyramidal structures 18 may be formed from materials having substantially the same refractive indices as at least a layer of the substrate portion 12.

The substrate portion 12 can have an additional optical characteristic that is different from the optical characteristics of the structured surface 14, that is, the substrate portion 12 would manipulate light in a way that is different from the way light would be manipulated by the structured surface 14. Such manipulation may include polarization selectivity, diffusion or additional redirection of light transmitted through the optical films of the present disclosure. This may be accomplished, for example, by including in the substrate portion an optical film having such an additional optical characteristic or constructing the substrate portion itself to impart such an additional optical characteristic. Exemplary suitable films having such additional optical characteristics include, but are not limited to, a polarizer film, a diffuser film, a brightness enhancing film such as BEF, a turning film and any combination thereof.

Turning film may be, for example, a reversed prism film (e.g., inverted BEF) or another structure that redirects light in a manner generally similar to that of a reversed prism film. In some exemplary embodiments, the substrate portion 12 may include a linear reflective polarizer, such as a multilayer reflective polarizer, e.g., Vikuiti™ Dual Brightness Enhancement Film (“DBEF”) or a diffuse reflective polarizer having a continuous phase and a disperse phase, such as Vikuiti™ Diff-use Reflective Polarizer Film (“DRPF”), both available from 3M Company. Additionally or alternatively, the substrate portion may include a polycarbonate layer (“PC”), a poly methyl methacrylate layer (“PMMA”), a polyethylene terephthalate (“PET”) or any other suitable film or material known to those of ordinary skill in the art. Exemplary suitable substrate portion thicknesses include about 125 μl for PET and about 130 μm for PC.

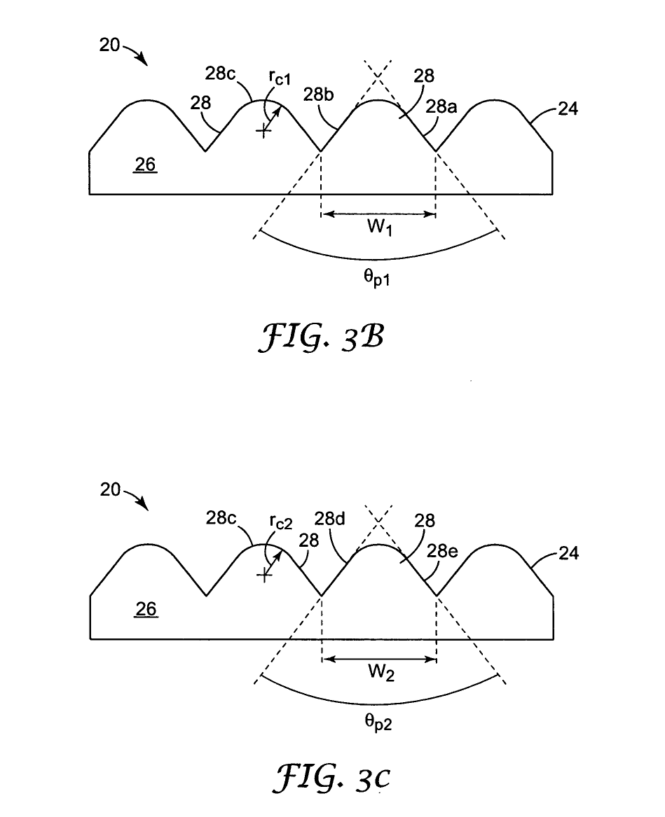

FIG. 3A is a partial perspective view of an exemplary optical film 20 according to the present disclosure, which has a structured surface 24 including rounded pyramidal structures 28 and a substrate portion 22. FIGS. 3B and 3C show cross-sectional views of the exemplary optical film 20 along the directions designated as 3B-3B and 3C-3C, respectively, in FIG. 3A. Referring to FIG. 3B, each rounded pyramidal structure 28 has a pair of generally opposing facets 28a and 28b, which define an included peak angle θₚ₁ and are characterized by a base width w₁. Referring to FIG. 3C, each rounded pyramidal structure 28 has another pair of generally opposing facets 28d and 28f, which define an included peak angle θₚ₂ and are characterized by a base width w₂.

In some exemplary embodiments, the included peak angles θₚ₁, θₚ₂ and the base widths w₁, w₂ are different, but in other exemplary embodiments they may be the same. The facets 28a, 28b, 28d and 28e of the pyramidal structures 28 meet to form peak tips 28c. The-exemplary peak tip 28c shown in FIGS. 3B-3C has a rounded contour. The rounded contour defined by the facets 28a and 28b is characterized by a radius of curvature r_{C1}, and the rounded contour defined by the facets 28d and 28e is characterized by a radius of curvature r_{C2}. In some exemplary embodiments, the radii r_{C1}, r_{C2} are different, but in other exemplary embodiments they may be the same. Alternatively or additionally, the valleys disposed between the bases of the pyramidal structures may be rounded. Included angles θₚ₁ and θₚ₂ are preferably in the range of about 70° to about 110°, but in other exemplary embodiments the angles θₚ₁ and θₚ₂ may be in the range of about 30° to about 120°. The base widths w1 and w2 are preferably in the range of about 20 to about 100 microns, but in other exemplary embodiments the base widths w1 and w2 may be in the range of about 5 to about 300 microns. The radii r_{C1}, r_{C2} are preferably no more than about 20% of the corresponding base widths, but in other exemplary embodiments the radii r_{C1}, r_{C2} may be up to about 40% of the corresponding base widths or more, depending on the acceptable value of the optical gain.

Exemplary optical films 20 may be manufactured by any method known to those of ordinary skill in the art including but not limited to embossing, casting, compression molding, and batch processes. In an exemplary method of manufacturing, a micro-structured form tool, and optionally an intermediate form tool, may be utilized to form the optical film (e.g. optical film 20). The micro-structured form tool may be made, for example, by cutting groves in two directions on a suitable substrate. As one of ordinary skill in the art will understand, the resultant micro-structured form tool will include a plurality of pyramidal structures resembling the desired optical film.

An intermediary form tool with a reverse or opposite structure to the micro-structured form tool (e.g. inverted pyramidal structures) may be manufactured from the micro-structured form tool using, for example, an electro-plating method or polymer replication. The intermediary form tool may be comprised of polymers including, for example, polyurethane, polypropylene, acrylic, polycarbonate, polystyrene, a UV cured resin, etc. The intermediate tool may also be coated with a release layer in order to facilitate release of the final optical film.

As one of ordinary skill in the art will understand, the intermediary form tool may be used to manufacture the optical film (e.g. optical film 20) via direct replication or a batch process. For example, the intermediary form tool may be used to batch process the optical film by such methods as injection molding, UV curing, or thermoplastic molding, such as compression molding. The optical film according to the present disclosure may be formed of or include any suitable material known to those of ordinary skill in the art including, for example, inorganic materials such as silica-based polymers, and organic materials, such as polymeric materials, including monomers, copolymers, grafted polymers, and mixtures or blends thereof.

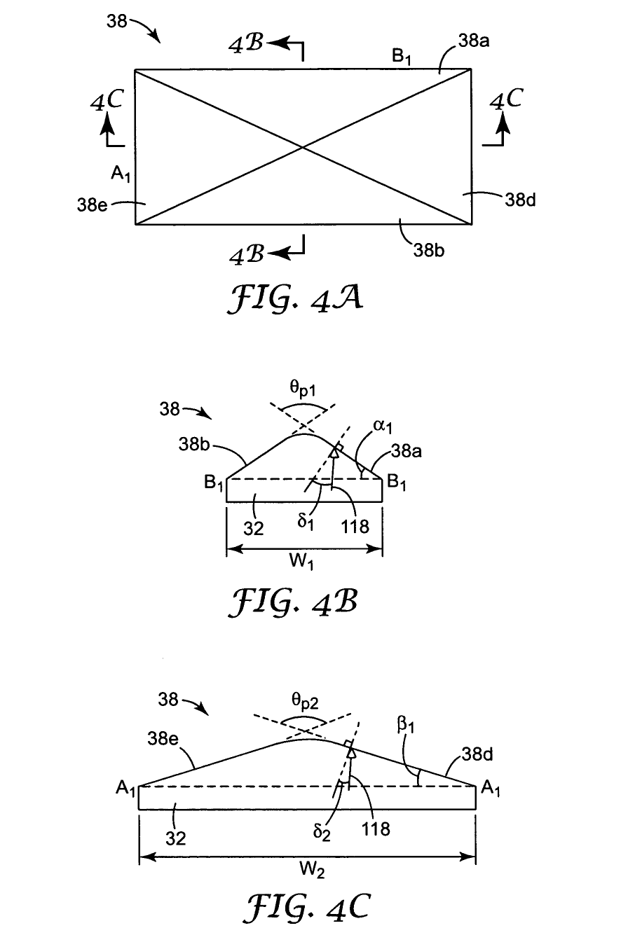

An exemplary individual rounded pyramidal structure 38 is shown in FIGS. 4A-4C. FIG. 4A shows a top view of the structure 38. The base of the prismatic structure 38 may be a four-sided shape with a first base width w₁ shown in FIG. 4B and a second base width w₂ shown in FIG. 4C. The base includes two first sides A₁, disposed generally opposite to each other along a direction shown as 4C, and two second sides B₁, disposed generally opposite to each other along a direction shown as 4B. In the exemplary embodiment shown in FIGS. 4A-4C, the length of w, is less than the length of w₂, the two first sides A₁ are substantially parallel to each other, and the two second sides B₁ are substantially parallel to each other. Furthermore, in this exemplary embodiment, the first sides A₁ are substantially perpendicular to the second sides B₁. Thus, the base of the pyramidal structure 38 may be substantially rectangular or square.

FIG. 4B shows a cross-sectional view of the pyramidal structure 38 in the 4B-4B plane as shown in FIG. 4A. The pyramidal structure 38 includes two facets 38a and 38b. The facets 38a and 38b define an included peak angle θₚ₁. One or both of the facets 38a, 38b also define an angle α₁ measured between one of the facets 38a, 38b and a plane parallel to a substrate portion 32. FIG. 4C shows a cross-sectional view of the pyramidal structure 38 in the 4C-4C plane as shown in FIG. 4A. The pyramidal structure 38 includes two facets 38d and 38e. The facets 38d and 38e define an included peak angle θₚ₂. One or both of the facets 38d, 38e also define an angle β₁ measured between one of the facets 38d, 38e and a plane parallel to the substrate portion 32. The angle α₁ can be as great as the angle β₁, smaller or larger.

FIGS. 4B and 4C show a light ray 118 traveling within the pyramidal structure 38. The surface 38a and the surface 38d may reflect or refract the light ray 118 depending on an incident angle δ₁ or δ₂ of the light ray 118 with respect to a normal to the surface 38a or the surface 38d. As one of ordinary skill in the art will understand from the present disclosure, selecting different angles α₁ and β₁ allows one to control the angular spread of light transmitted through the prismatic structures 38 of an optical film (e.g., optical film 20). In some exemplary embodiments, the angles between the opposing pairs of surfaces and a plane parallel to a substrate portion are not equal to each other, which may be advantageous where a viewing axis that is tilted with respect to a normal to the substrate portion is desired.

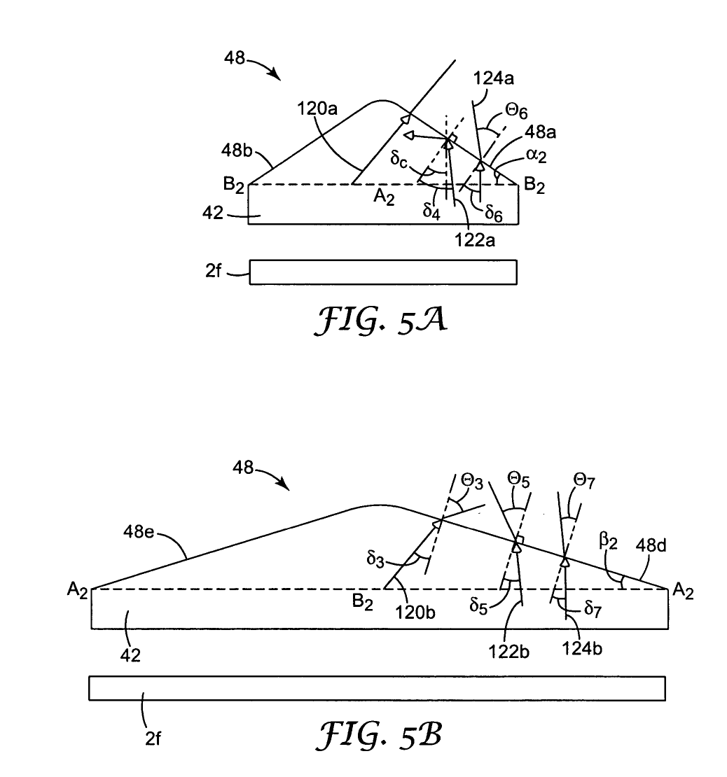

FIG. 5A shows a cross-sectional view of an individual exemplary pyramidal structure 48 of an optical film according to the present disclosure. A light ray 120a, a light ray 122a, and a light ray 124a, emitted from a backlight 2f, propagate in the pyramidal structure 48. FIG. 5B shows another cross-sectional view of the exemplary embodiment of the pyramidal structure 48. A light ray 120b, a light ray 122b, and a light ray 124b, which have the same directions as light rays 120a, 122a, and 124a respectively, shown in FIG. 5A, originate from the backlight 2f and propagate in the pyramidal structure 48.

The following describes the travel of each of the light rays 120-124, originating from a backlight 2f, through the pyramidal structure 48 of an optical film constructed according to the present disclosure. FIGS. 5A and 5B show how a light ray may behave differently depending on whether it first impacts the surface 48a or the surface 48d, and how the angular spread of light may be controlled in two separate directions by selecting an angle α₂ of a surface 48a and/or an angle β₂ of a surface 48d. It should be noted that the light rays 120-124 are not drawn to precisely illustrate the angles of reflection and refraction of the light rays 120-124. The light rays 120-124 are only shown to illustrate schematically the general direction of travel of the light rays through the pyramidal structure 48.

In FIG. 5A, the light ray 120a originating from the backlight 2f travels in the pyramidal structure 48 in a direction perpendicular to the surface 48a. Thus, the light ray 120a encounters the surface 48a such that an incident angle of the light ray 120a relative to the normal of the surface 48a is equal to zero degrees. A medium above the surfaces 48a and 48d may be, for example, comprised substantially of air. However, the medium above the surfaces 48a and 48d may be comprised of any medium, material, or film known to those of ordinary skill in the art.

As one or ordinary skill in the art would understand, air has a refractive index less than most known materials. Based on the principles of Snell's Law, when light encounters, or is incident upon, a medium having a lesser refraction index, the light ray is bent away from the normal at an exit angle 0 relative to the normal that is greater than an incident angle δ. However, a light ray which encounters a material-air boundary at surface such that it is normal to the surface (e.g., the light ray 120a) is not bent and continues to travel in a straight line as shown in FIG. 5A. Snell's Law can be expressed by the formula:
nᵢ* sin δ=nₜ* sin 74 ,
where,
nᵢ=the refractive index of the material on the side of incident light,
δ=the incident angle,
nₜ=the refractive index of the material on the side of transmitted light, and
θ=the exit angle.
   Those of ordinary skill in the art will understand that a certain amount of the incident light will also be reflected back into the pyramidal structure 48.

FIG. 5B shows the light ray 120b traveling in substantially the same direction as the light ray 120a. The light ray 120b encounters the surface 48d at the incident angle δ₃ relative to a normal to the surface 48d. In the embodiment shown in FIGS. 5A-5B, the angle β₂ of the surface 48d is less than the angle α₂ of the surface 48a. Thus, the incident angle δ₃ of the light ray 120b is therefore not equal to the incident angle δ of the light ray 120a. The incident angle δ₃ of the light ray 120b is not equal to zero as shown in FIG. 5B, and the light ray 120b does not encounter the material-air boundary perpendicular to the surface 48d. The light ray 120b is refracted at an exit angle θ₃ different from the incident angle δ₃ at which it impacted the surface 48d based on the formula of Snell's Law.

As shown in FIG. 5A, the light ray 122a travels into the structure 48 and encounters the surface 48a at the incident angle δ₄ relative to the normal to the surface 48a. The incident angle δ₄ for the light ray 122a is greater than the critical angle δ_{c} at the surface 48a. The light ray 122a does not exit the structure 48 and is reflected back into the structure 48. This is referred to as “total internal reflection.” As described above, the light ray will behave according to the formula for refraction set forth above when traveling from a material having a higher refractive index to a material having a lower refractive index. According to the formula, the exit angle θ will approach 90 degrees as the incident angle increases. However, at the critical angle δ_{c}, and for all angles greater than the critical angle δ_{c}, there will be total internal reflection (e.g., the light ray will be reflected back into the structure 48 rather than being refracted and transmitted through the surface). As one of ordinary skill in the art would understand, the critical angle δ_{c}, may be determined according to the Snell's Law (described above) by setting the exit angle (e.g., refraction angle) to 90 degrees and solving for the incident angle δ.

As shown in FIG. 5B, the light ray 122b, traveling in substantially the same direction as the light ray 122a, encounters the surface 48d. Because the angle β₂ of the surface 48d is less than the angle α₂ of the surface 48a, the light ray 122b encounters the surface 48d at a different incident angle δ₅ than the incident angle δ₄ at which the light ray 122a encountered the surface 48a. The incident angle of light ray 122b is less than the critical angle δc and, therefore, the light ray 122b is refracted at the surface 48d and transmitted through the surface 48d.

The light ray 124a and the light ray 124b, shown in FIGS. 5A and 5B respectively, travel in the pyramidal structure 48 in a direction perpendicular to the substrate portion 42. The light rays 124a and 124b encounter the surface 48a and the surface 48d, respectively, at incident angles δ less than the critical angle δ_{c}. However, the incident angle δ₆ of the light ray 124a relative to the normal of the surface 48a is greater than the incident angle δ₇ of the light ray 124b relative to the normal of the surface 48d. Hence, according to Snell's Law, the exit angle θ₆ of the light ray 124a relative to the normal of the surface 48a will be different than the exit angle θ₇ of the light ray relative to the normal to the surface 48d. As one of ordinary skill in the art would understand, the exit angle θ₆ of the light ray 124a relative to the normal of the surface 48a will be greater than the exit angle θ₇ of the light ray 124b relative to the normal of the surface 48d.

As one of ordinary skill in the art would understand, the surface 48d with the greater angle α₂ may generally “focus” more light toward a direction perpendicular to the backlight 2f than the surface 48a with the lesser angle β₂. Thus, an optical film with rounded pyramidal structures 48 as described above may allow a greater angular spread of light along one direction and a lesser angular spread of light along another direction. For example, an exemplary optical film of the present disclosure may be employed in an LCD television to provide a wider angular spread of light in a first direction, e.g., the horizontal direction, and a lesser but still substantial angular spread of light in a second direction, e.g., the vertical direction. This may be advantageous to accommodate the normally wider field of view in the horizontal direction (e.g., viewers on either side of the television) than in the vertical direction (e.g., viewers standing or sitting). In some exemplary embodiments, the viewing axis may be tilted downward, such as where a viewer may be sitting on the floor. By reducing the angular spread of light in the vertical direction, an optical gain may be experienced in a desired viewing angle range. Generally, rounding the peaks of the pyramidal structures may have one or more of the following advantages: the viewing angle cutoff is softened by the curvature, which may make it less apparent to a viewer of the display device; the curved peaks make the film less likely to be damaged during handling than a similar film with sharp peaks; rounded peaks, in certain cases, reduce the amount light emitted from the structures at glancing angles (70 to 90 degrees from normal), so that rounded peaks in certain cases may improve contrast when compared to sharp peaks. Rounding the valleys of the pyramidal structures also may soften the viewing angle cutoff is softened by the curvature, which may make it less apparent to a viewer of the display device.

Traditionally, diffusers have been used to widen a field of view of display devices. Exemplary embodiments of the present disclosure provide a relatively wider field of view, which may be controlled independently along two different directions. Unlike most traditional diffusers, the optical films of the present disclosure do not primarily rely on scattering incident light or redirect it due to variations in refractive index within the diffuser's body. Instead, the present disclosure provides optical films that can cause angular spread of the incident light due to the geometrical configuration of their structured surfaces and also provide gain of at least about 1.1.

### EXAMPLES

The present disclosure will be further illustrated with reference to the following examples representing modeled properties of some exemplary optical films constructed according to the present disclosure.

### Example 1

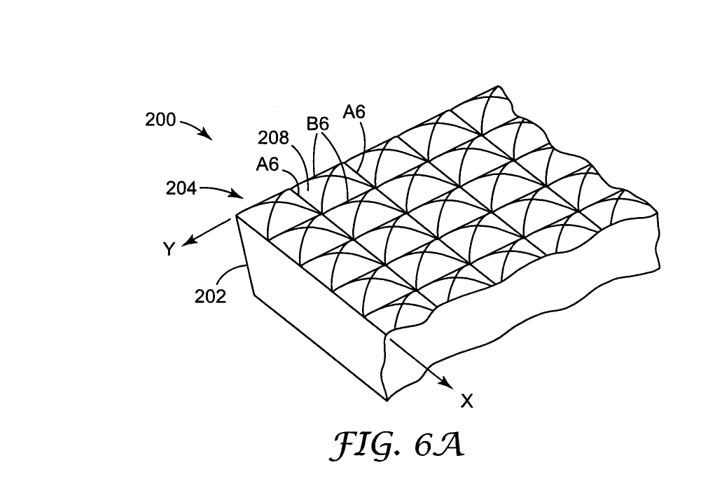

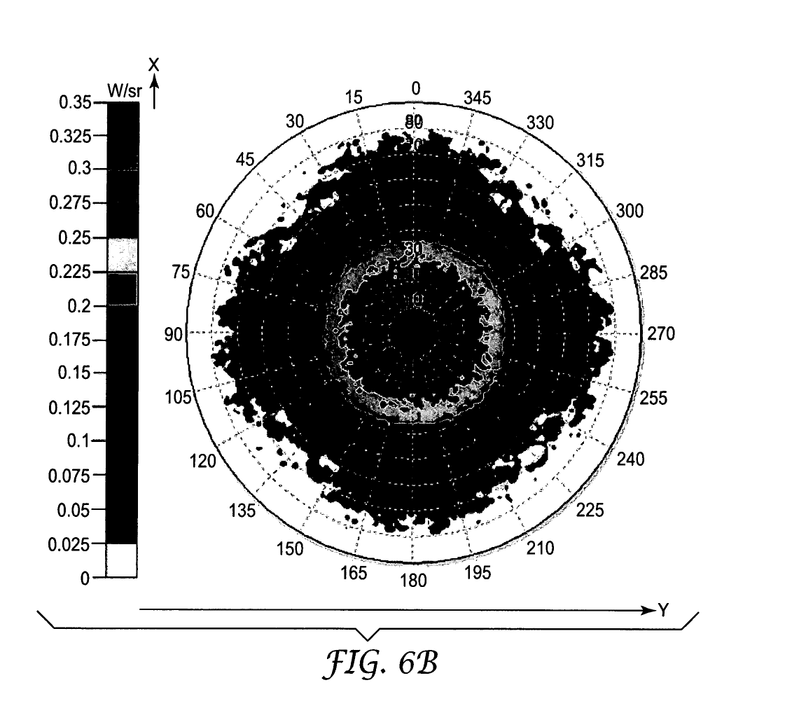

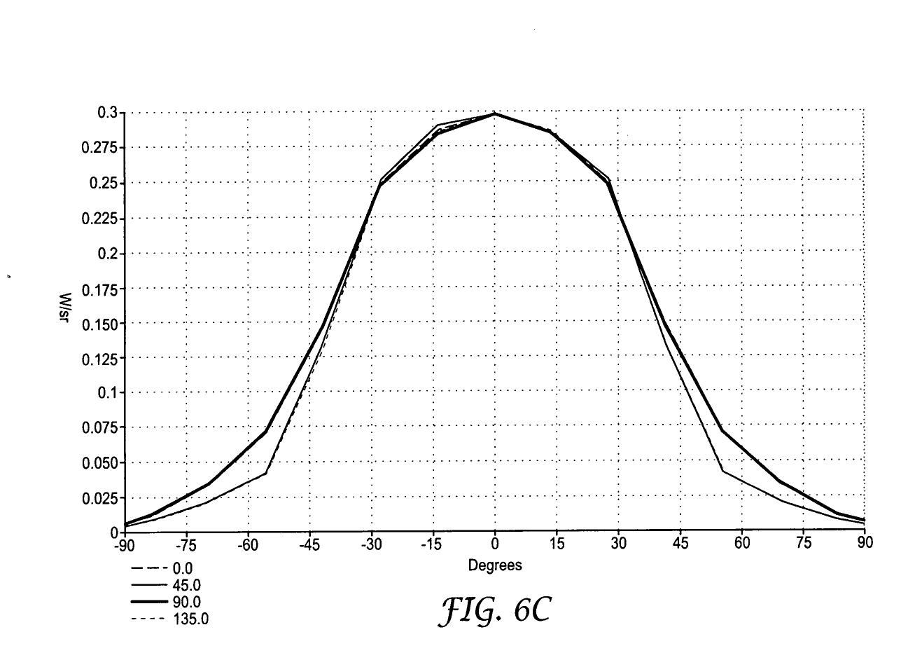

FIG. 6A shows a schematic partial perspective view of an exemplary modeled optical film 200 according to the present disclosure. The exemplary optical film 200 includes a substrate portion 202 and a structured surface 204 carrying closely packed rounded pyramidal structures 208. In this exemplary embodiment, the pyramidal structures 208 are immediately adjacent to each other. A base of each of the pyramidal structures 208 was modeled as a four-sided shape with two first sides A₆, disposed generally opposite to each other along a direction Y, and two second sides B₆, disposed generally opposite to each other along a direction X. Each pyramidal structure of this exemplary embodiment had a square base with a side of about 50 microns and a rounded tip with both radii of curvature of about 24 microns and a refractive index of about 1.58. The peak angles were both set to about 90 degrees. The substrate portion was modeled as a substantially planar film with a refractive index of about 1.66.

FIG. 6B represents a calculated polar iso-candela distribution plot for light exiting an optical film having the structure substantially as shown in FIG. 6A placed over a backlight with the structured surface 204 facing away from the light source. The distribution for all Examples was calculated using the following model: an extended Lambertian source was used on the first pass of light through the optical film and the remaining light was recycled using a Lambertian reflector with a reflectivity of about 77.4%. As one of ordinary skill in the art will understand, the iso-candela distribution plots show a three hundred and sixty degree pattern of detected incident light rays having passed through the optical film. As it is apparent from FIG. 6B, the output light distribution of this exemplary embodiment has a relatively high degree of cylindrical symmetry, and the intensity decreases relatively monotonically without forming secondary peaks at high angles. Furthermore, as shown in FIG. 6B, the distribution of the light transmitted through the optical film along the Y direction is similar to the distribution along the X direction.

FIG. 6C shows rectangular candela distribution plots. As one of ordinary skill in the art will understand, each curve on the rectangular distribution plots corresponds to a different cross-section of the polar plot. For example, the curve designated as 0 degrees represents the cross-section of the polar plot along the line passing through the center that connects 0 and 180 degrees and corresponding to the X direction in FIG. 6A, the curve designated as 45 degrees represents the cross-section of the polar plots along the line passing through the center that connects 45 and 225 degrees, the curve designated as 90 degrees represents the cross-section of the polar plots along the line passing through the center that connects 90 and 270 degrees and corresponding to the Y direction in FIG. 6A, and the curve designated as 135 degrees represents the cross-section of the polar plots along the line passing through the center that connects 135 and 315 degrees.

FIG. 6C also illustrates a relatively high degree of cylindrical symmetry of the output light distribution of this exemplary embodiment, as well as relatively monotonically decreasing intensity without secondary peaks at high angles. This conclusion is illustrated by relatively small differences between the rectangular intensity plots along the two orthogonal directions, corresponding to X and Y in FIG. 6A. Modeled optical gain for the exemplary optical films constructed according to FIG. 6A was found to be about 1.43.

### Example 2

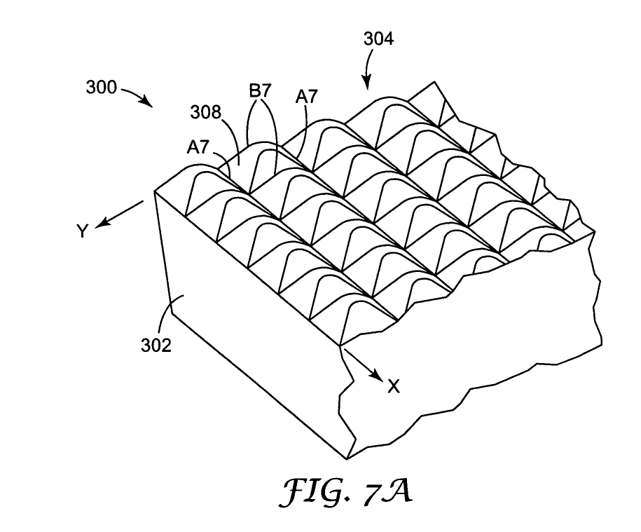

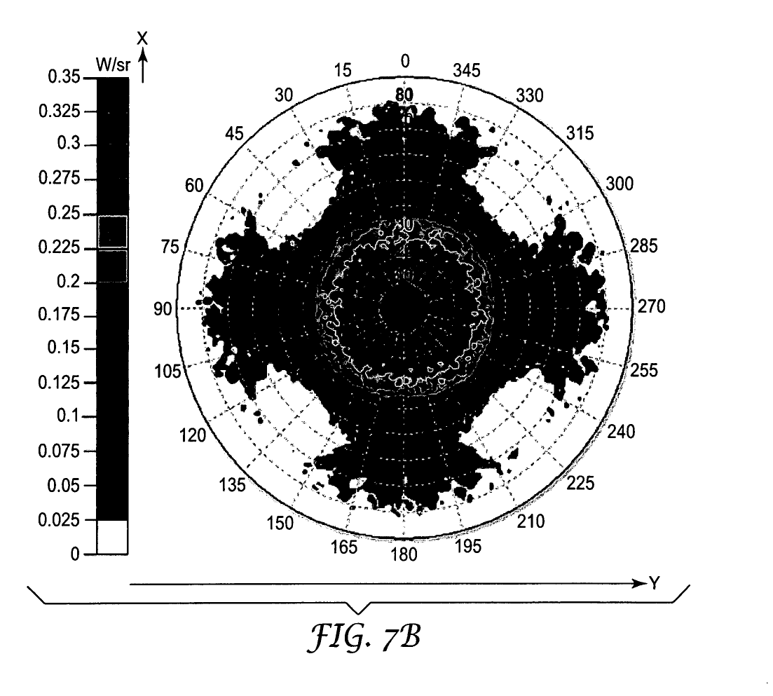

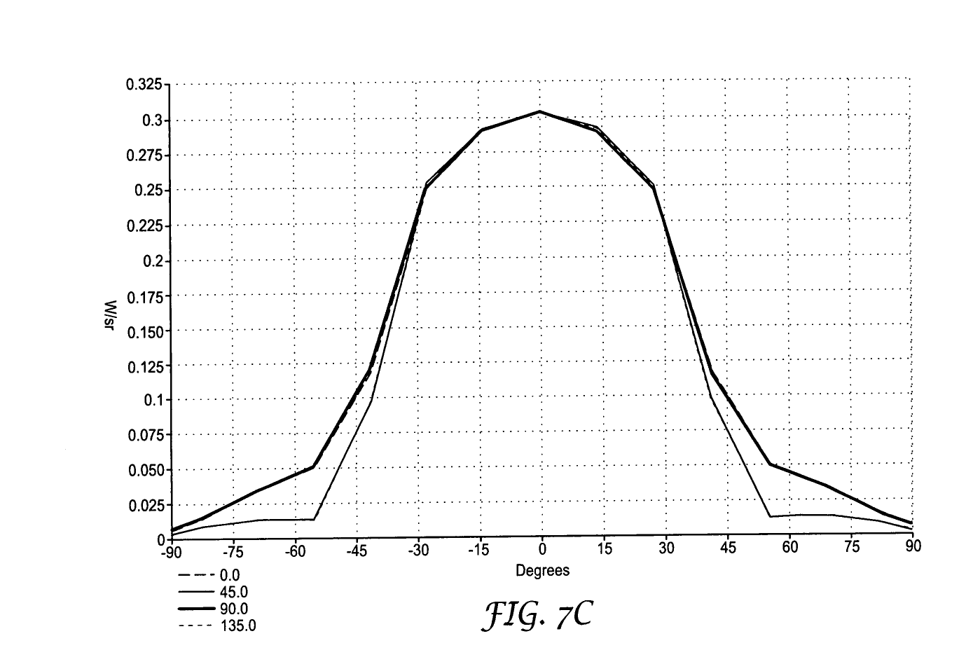

FIG. 7A shows a schematic partial perspective view of an exemplary modeled optical film 300 according to the present disclosure. The exemplary optical film 300 includes a substrate portion 302 and a structured surface 304 carrying closely packed rounded pyramidal structures 308. In this exemplary embodiment, the pyramidal structures 308 are also immediately adjacent to each other. A base of each of the pyramidal structures 308 was modeled as a four-sided shape with two first sides A₇, disposed generally opposite to each other along a direction Y, and two second sides B₇, disposed generally opposite to each other along a direction X. Each pyramidal structure of this exemplary embodiment had a square base with a side of about 50 microns and a rounded tip with both radii of curvature of about 12 microns and a refractive index of about 1.58. The peak angles were both set to about 90 degrees. The substrate portion was modeled as a substantially planar film with a refractive index of about 1.66.

FIG. 7B represents a calculated polar iso-candela distribution plot for light exiting an optical film having the structure substantially as shown in FIG. 7A placed over a backlight with the structured surface 304 facing away from the light source. As it is apparent from FIG. 7B, the output light distribution of this exemplary embodiment also has a relatively high degree of cylindrical symmetry, and the intensity decreases relatively monotonically without forming secondary peaks at high angles. Furthermore, as shown in FIG. 7B, the distribution of the light transmitted through the optical film along the Y direction is similar to the distribution along the X direction.

FIG. 7C shows rectangular candela distribution plots. In these plots, the curve designated as 0 degrees represents the cross-section of the polar plot along the line passing through the center that connects 0 and 180 degrees and corresponding to the X direction in FIG. 7A, the curve designated as 45 degrees represents the cross-section of the polar plots along the line passing through the center that connects 45 and 225 degrees, the curve designated as 90 degrees represents the cross-section of the polar plots along the line passing through the center that connects 90 and 270 degrees and corresponding to the Y direction in FIG. 7A, and the curve designated as 135 degrees represents the cross-section of the polar plots along the line passing through the center that connects 135 and 315 degrees.

FIG. 7C also illustrates a relatively high degree of cylindrical symmetry of the output light distribution of this exemplary embodiment, as well as relatively monotonically decreasing intensity without secondary peaks at high angles. This conclusion is illustrated by relatively small differences between the rectangular intensity plots along the two orthogonal directions, corresponding to X and Y in FIG. 7A. Modeled optical gain for the exemplary optical films constructed according to FIG. 7A was found to be about 1.56.

### Example 3

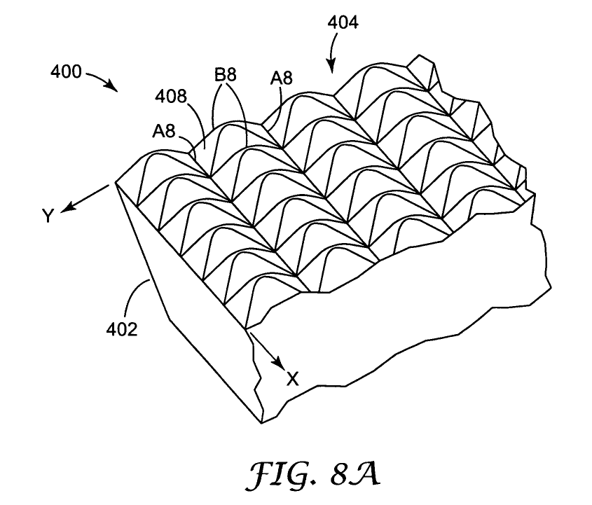

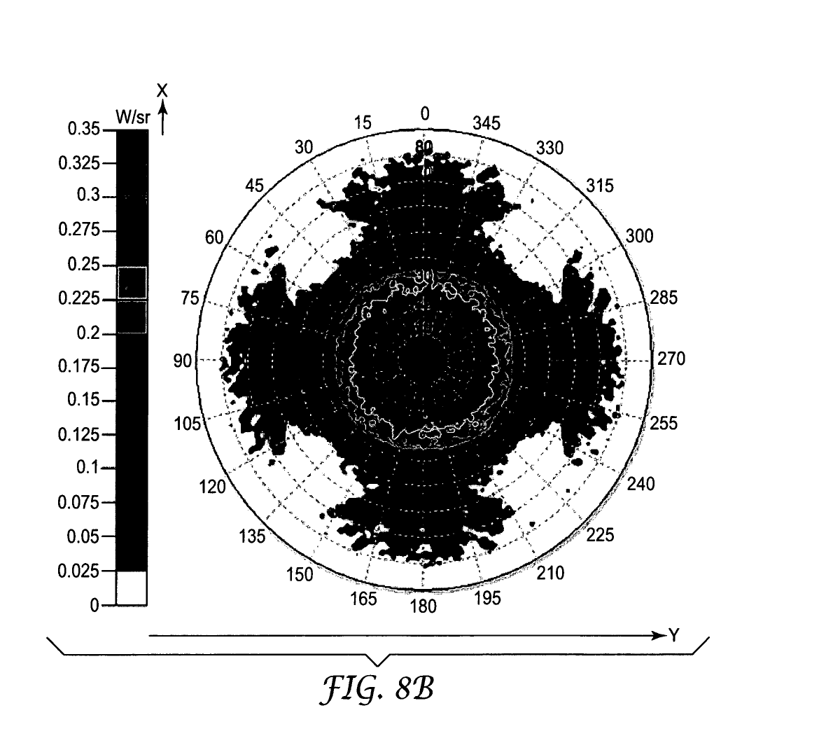

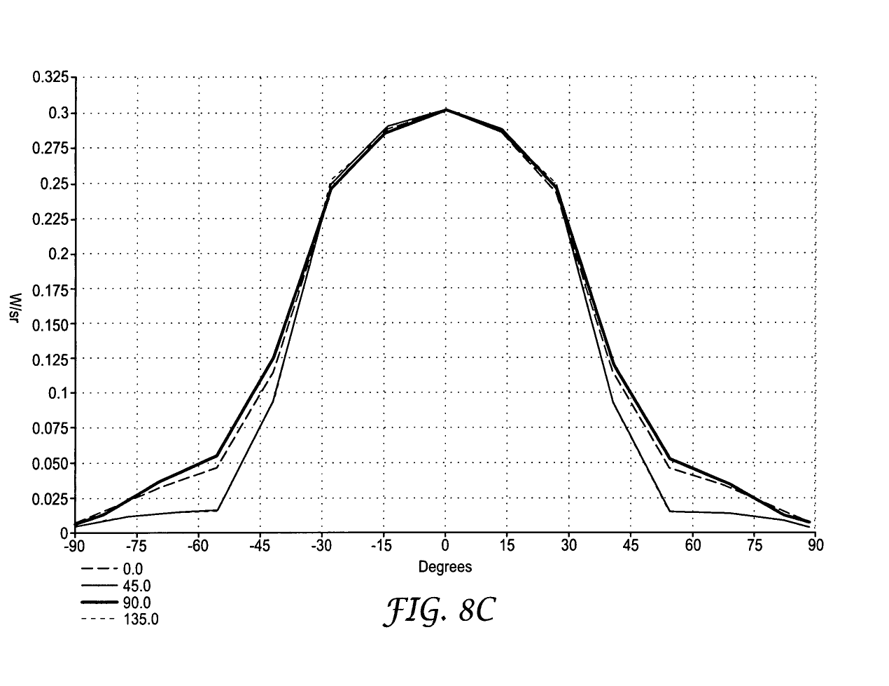

FIG. 8A shows a schematic partial perspective view of an exemplary modeled optical film 400 according to the present disclosure. The exemplary optical film 400 includes a substrate portion 402 and a structured surface 404 carrying closely packed rounded pyramidal structures 408. In this exemplary embodiment, the pyramidal structures 408 are also immediately adjacent to each other. A base of each of the pyramidal structures 408 was modeled as a four-sided shape with two first sides A₇, disposed generally opposite to each other along a direction Y, and two second sides B₇, disposed generally opposite to each other along a direction X. Each pyramidal structure of this exemplary embodiment had a rectangular base with the longer side of about 55 microns, the shorter side of about 50 microns, a rounded tip with both radii of curvature of about 6 microns and a refractive index of about 1.58. The larger peak angle was set to about 90 degrees. The substrate portion was modeled as a substantially planar film with a refractive index of about 1.66.

FIG. 8B represents a calculated polar iso-candela distribution plot for light exiting an optical film having the structure substantially as shown in FIG. 8A placed over a backlight with the structured surface 404 facing away from the light source. As it is apparent from FIG. 8B, the intensity decreases relatively monotonically without forming secondary peaks at high angles. FIG. 8C shows rectangular candela distribution plots. In these plots, the curve designated as 0 degrees represents the cross-section of the polar plot along the line passing through the center that connects 0 and 180 degrees and corresponding to the X direction in FIG. 8A, the curve designated as 45 degrees represents the cross-section of the polar plots along the line passing through the center that connects 45 and 225 degrees, the curve designated as 90 degrees represents the cross-section of the polar plots along the line passing through the center that connects 90 and 270 degrees and corresponding to the Y direction in FIG. 8A, and the curve designated as 135 degrees represents the cross-section of the polar plots along the line passing through the center that connects 135 and 315 degrees.

FIG. 8C also illustrates relatively monotonically decreasing intensity without secondary peaks at high angles. Unlike the embodiments of Examples 1 and 2, the exemplary embodiment of Example 3 is characterized by a wider light distribution along the Y direction than along the X direction, which is illustrated by a generally wider 90 degree curve, as compared to the 0 degree curve. Modeled optical gain for the exemplary optical films constructed according to FIG. 8A was found to be about 1.56.

Thus, the present disclosure provides optical films that can be configured to exhibit a specific controllable angular spread of light on the viewing side without loss of transmission. Further, optical films of the present disclosure can exhibit optical gain. The amounts of gain and angular spread will depend on the specific configuration of the surface structures and may be varied to achieve the performance desired for a particular application. In addition, since the surface features may be rounded, the embodiments of the present disclosure can have increased robustness.

Although the optical films and devices of the present disclosure have been described with reference to specific exemplary embodiments, those of ordinary skill in the art will readily appreciate that changes and modifications may be made thereto without departing from the spirit and scope of the present disclosure.

What is claimed is:

1. An optical film, comprising:
a body having a first surface, an axis and a structured surface including a plurality of pyramidal structures, each pyramidal structure having a rounded tip and a base including at least two first sides disposed opposite to each other and at least two second sides disposed opposite to each other; and
a substrate portion having an additional optical characteristic different from an optical characteristic of the structured surface.

2. The optical film according to claim 1, wherein the substrate portion comprises at least one of: a polarizer, a diffuser, a brightness enhancing film, and a turning film.

3. The optical film according to claim 2, wherein the polarizer is a linear reflective polarizer.

4. The optical film according to claim 1, further comprising an adhesive disposed between the structured surface and the substrate portion.

5. The optical film according to claim 1, wherein the substrate portion comprises the same material as the structured surface.

6. The optical film according to claim 1, wherein the body portion and the substrate portion each have a refractive index, the refractive index of the body portion being different than the refractive index of the substrate portion.

7. The optical film as recited in claim 1, wherein the two first sides are disposed opposite to each other along a first general direction and the two second sides are disposed opposite to each other along a second general direction,
wherein the optical film transmits a substantial portion of light incident on the first surface along the first general direction when an angle of incidence is within a first angle with respect to an axis disposed at an angle to the first surface and reflects a substantial portion of light when the angle of incidence is outside the first angle,
wherein the optical film transmits a substantial portion of light incident on the first surface along the second general direction when an angle of incidence is within a second angle with respect to the axis and reflects a substantial portion of light when the angle of incidence is outside the second angle, and
wherein the first angle is different from the second angle.

8. The optical film as recited in claim 7, wherein the axis is generally orthogonal to the first surface.

9. The optical film according to claim 1, wherein the base has a generally rectangular or a generally square shape.

10. The optical film according to claim 1, wherein each of the plurality of pyramidal structures is further characterized by a peak angle that lies within a range of about 30 degrees to about 120 degrees.

11. The optical film according to claim 1, wherein the rounded tip is characterized by a radius of curvature that is no more than about 20% of a corresponding base width.

12. The optical film according to claim 1, wherein each of the plurality of prismatic structures is arranged in contact with at least one other prismatic structure.

13. An optical device comprising a light source and the optical film of claim 1 disposed so that the structured surface faces away from the light source.

14. The optical device according to claim 13, further comprising a light gating device disposed to receive light transmitted through the optical film.

15. The optical film according to claim 1, wherein the bases of the plurality of prismatic structures are aligned with the two longer sides of each of the bases substantially parallel to one another.

16. An optical film, comprising:
a body having a first surface, an axis and a structured surface including a plurality of pyramidal structures, each pyramidal structure having a rounded tip and a base including at least two longer sides disposed opposite to each and at least two shorter sides disposed opposite to each other.

17. The optical film of claim 16, wherein the base has a generally rectangular shape.

18. The optical film of claim 16, wherein the longer sides of each of the plurality of pyramidal structures are disposed substantially parallel to each other and the shorter sides are disposed substantially parallel to each other.

19. An optical device comprising a light source and the optical film of claim 16 disposed so that the structured surface faces away from the light source.

20. The optical film according to claim 16, further including a substrate portion that comprises at least one of: a polarizer, a diffuser, a brightness enhancing film, and a turning film.
